(19) United States
(12) Patent Application Publication
(10) Pub. No.: US 2017/0103056 A1
(43) Pub. Date: Apr. 13, 2017

(54) METHOD AND SYSTEM FOR CHECKING NATURAL LANGUAGE IN PROOF MODELS OF MODAL LOGIC

(71) Applicant: Ersatz Systems Machine Cognition, LLC, Colorado Springs, CO (US)

(72) Inventors: Colin James, III, Colorado Springs, CO (US); Garry Goodwin, Hertfordshire (GB)

(21) Appl. No.: 15/275,925

(22) Filed: Sep. 26, 2016

Related U.S. Application Data
(60) Provisional application No. 62/239,701, filed on Oct. 9, 2015.

(51) Int. Cl. G06F 17/27

(52) U.S. Cl. CPC G06F 17/271; G06F 17/274; G06F 17/2785

(57) ABSTRACT

A system for checking natural language in proof models of modal logic includes parsing natural language for parts of speech mapping (POSM) into logical symbols and expressions, then proving the logical expression in the logic model checker (LCM) by modal logic. The LCM is applied to computer program validation and requirement document verification.

### CROSS REFERENCE TO RELATED APPLICATION

The present application claims the benefits of and priority, under 35 U.S.C. §119(e), to U.S. Provisional Application Ser. No. 62/239,701, filed Oct. 9, 2015, entitled “APPARATUS TO PROVE MODAL THEOREMS USING A FOUR-VALUED LOGIC SYSTEM.” The aforementioned document is incorporated herein by this reference in its entirety for all that it teaches and for all purposes.

### FIELD OF THE INVENTION

The present invention generally relates to the framework for automated reasoning, universal logics, logic model checkers, and natural language mapping to logics, and more particularly to a method and system for mapping parts of speech to logical expressions for proof by truth table in models of modal logic.

### SUMMARY OF THE INVENTION

There is a need for a method and system for checking natural language in proof models of modal logic. The need is based on a perfect logical calculus to model perfect proofs. The goal is to validate sentences, paragraphs, and documents as logical expressions from natural language. To that end it is required to map words to logical symbols so as to build sentences as logical expressions for checking by logic models. Results of proof values for sentences are connected together by implication for results of paragraphs, and these in turn are connected together by implication for results of documents as truth table proofs.

One advantage of the present invention is to rely solely on the logic named VL4 which is the only known logic system capable of producing a minimal set of atoms for logic S5.

A second advantage of the present invention is to provide proof by the five logic models of VL4.

A third advantage of the present invention is to provide an exact decomposition of natural language sentences into parts of speech (POS) which in turn map directly into logical symbols to build the logical expressions to be checked.

A fourth advantage of the present invention is to link sentences as literals by the implication connective to form paragraphs into a document to produce a proof result by the constituent truth tables.

The aforementioned advantages are implemented in the invention by unique features:

First, shift window parsing (SWP) for the faster parsing of the parenthetical logical expression;

Second, conditional symbol spoofing (CSS) for a more compact processing of the logical argument;

Third, an arithmetic algorithm to verify the correct number of literals, connectives, and parentheses in the logical expression;

Fourth, clustering parts of speech into abstract groups such as including the conjunction as a verb and the preposition as an adjective.

Fifth, the unfolding of a sentence or phrase to expand clarity as rewritten or as written into multiple sentences.

Sixth, the catentation of proof tables for sentences with the imply connective to build subsequent proof tables for paragraphs, and in turn to build the subsequent catenation into larger sections to compose the final document.

The above and other needs are addressed by embodiments of the present invention, which provide a system and method that can be applied to other logic systems to be mirrored and checked as based on the five models of VL4.

### BRIEF DESCRIPTION OF THE DRAWINGS

The embodiments of the present invention are illustrated by way of example, and not by way of limitation, in the figures of the accompanying drawings:

FIG. 1.0 illustrates a computing machine for the logic model checker (LMC) based on the proof tables of VL4.

FIG. 1.2 illustrates the lookup tables (LUT) built for Operators and Connectives.

FIG. 1.4 illustrates the input logic validation (ILV) as performed on the input of the logical expression for Character Set, Syntax, and Counting Types.

FIG. 1.5 illustrates the logic parse process (LPP) performed on the syntactically correct logical characters to decompose the the expression into arguments using the unique shift-window parsing (SWP).

FIG. 1.6 illustrates the logic parse validation (LPV) to check that the logical expression is a well formed formula (wff), raise exceptions, and direct program flow.

FIG. 1.7 illustrates the process of substitution of argument (SOA) from truth values in LUT and from results raised and substituted to the next level of argument using the unique conditional symbol spoofing (CSS).

FIG. 1.8 illustrates model proof output (MPO) where truth tables for each argument are output to persistent file and to desktop monitor at each level level of argument.

FIG. 2.0 illustrates a computing machine for the language parser that finds parts of speech in a sentence then maps them into logical symbols to form a logical expression. This is named a part of speech mapper (POSM).

FIG. 2.2 illustrates building a parts of speech dictionary (POSD) by reading an external file into a string.

FIG. 2.4 illustrates input of the natural language sentence validation (NLSV) as performed on the input of the sentence by Character Set.

FIG. 2.5 illustrates the parts of speech search (POSS) based on the string search mechanism for word retrieval of the attendant parts of speech.

FIG. 2.6 illustrates the parts of speech validation (POSV) of each word in the sentence to ensure there is the equivalent of at least one verb and two nouns.

FIG. 2.7 illustrates the substitution of parts of speech to logic (POSL) for mapping into logical symbols.

FIG. 2.8 illustrates the logical expression symbol output (LESO) to persistent file, desktop monitor, and logic model checker (LCM) as in FIG. 1.0, Step 130.

### DISCLOSURE OF THE INVENTION

The disclosure of the invention contains three original and unique parts: the logic system (VL4); the logic model checker (LMC); and the part of speech (POSM).

The logic system VL4 is described below.

Abstract

Two methods for modelling formal languages are examined here. First a bivalent framework is used to weaken a class of many valued logics with twin functors. Second the idea of primary values is introduced. Primary values are the maximal number of contrary formulae expressible in the language. The set of primary values is equally as important as the set of axioms. In the spirit of Suszko's Thesis, from Roman Suszko, The Fregean axiom and Polish mathematical logic in the 1920's, Studia Logica, 36:373-380, 1977 (“Suszko 1977”), herein incorporated by reference in its entirety for all purposes, the set is evaluated as a two valued logic. An example provided is the primary set for S5's binary fragment. This approach informs an automated theorem prover/model checker in the next part of the disclosure of this invention in which the implements elements of the semantic framework as elucidated in the first part.

Introduction

A formal language is characterized as a many valued logic with the generic structure:
General Structure: [T^{Π}, T^{V}: (V^{T}, Vⁿ, V^{⊥}), [symbol] , ˜, &, v, →, [symbol] , ⇄, v, Δ, +Δ, −Δ]
   T^{Π} is the set of truth possibilities. T^{V} is the set of truth values. V^{T} is the set of designated values, V^{⊥} is the set of falsifying values, and Vⁿ the set of non designating values not false. Table 1 and Table 2 offer two versions of validity.

TABLE 1

| | | | |
|---|---|---|---|
| ₁ [symbol] | V [symbol] | Vⁿ | V^{⊥} |

| | |
|---|---|
| V [symbol] | [symbol] |
| Vⁿ | |
| V^{⊥} | |

TABLE 2

| | | | |
|---|---|---|---|
| ₂ [symbol] | V [symbol] | Vⁿ | V^{⊥} |

| | |
|---|---|
| V [symbol] | [symbol] |
| Vⁿ | [symbol] |
| V^{⊥} | |

Table 1 is the minimum threshold for validity. Table 1 in words:

Γ₁ [symbol] A (1.0)
iff there are no models such that all values of Γ
are true and A is false.

Table 1 may prove insecure for many valued logic and is strengthened as Table 2. In words:

Γ₂ [symbol] A (1.1)
iff there are no models such that all values of Γ
are non falsifying and A is false.

Other elements of the general structure are defined on Table 3. The triangular notation Δ marks the presence of a functor.

Bivalent Framework

The bivalent framework evaluates the two truth possibilities p is case and p is not the case. Two valued logic is as Table 3.

TABLE 3

| | p | ~p | [symbol] | ⊥ |
|---|---|---|---|---|
| p is the case | T | F | T | F |
| p is not the case | F | T | T | F |

On Table 3 the truth conditions are tautological. For example, to assert ‘p’ means p is the case is true when p is not the case is false.

The bivalent framework was originally designed to weaken the four valued modal logic of Jan Lukasiewicz, A system of modal logic, The Journal of Computing Systems, 1, 111-149, 1953 (“Lukasiewicz 1953”) and Jan Lukasiewicz, Aristotle's Syllogistic Logic (Second Edition), Clarendon Press, Chapter VII, 1957 (“Lukasiewicz 1957”), both herein incorporated by reference in their entirety for all purposes. L₄ is a B₄ algebra with twin modal functors as Table 4.

TABLE 4

| | | Δ | | ∇ | |
|---|---|---|---|---|---|
| | ~ | □ | ⋄ | □ | ⋄ |
| 1 | 0 | 2 | 1 | 3 | 1 |
| 2 | 3 | 2 | 1 | 0 | 2 |
| 3 | 2 | 0 | 3 | 3 | 1 |
| 0 | 1 | 0 | 3 | 0 | 2 |

Despite L₄'s conservatism it has multiple complaints; 2.0 is a noted egregious L₄ theorem:

[symbol]

_{L4}(⋄p & ⋄q)→⋄(p & q) (2.0)

Jean-Yves Béziau in A new four valued approach to modal logic, Logique et Analyse, 54, (“Béziau 2011”), herein incorporated by reference in its entirety for all purposes, points out 2.0 proved a nightmare for Lukasiewicz. Consider the counter: If it is possible the President is in Washington and possible the President is in London, then, it is possible the President is both in Washington and London. It is clear L₄ is untenable as an alethic logic, so L₄ may be rehabilitated. Table 5 introduces the Lukasiewicz functor to the bivalent framework.

TABLE 5

| | p | ~p | □p | ~□p | ⋄p | ~p |
|---|---|---|---|---|---|---|
| p is the case | 1 | 0 | 2 | 3 | 1 | 0 |
| p is not the case | 0 | 1 | 0 | 1 | 3 | 2 |

For Table 5 if 1 is interpreted as true and 0 is false, this begs the question as how to interpret 2 and 3. For an answer, one may refer to basic RGB color theory for additive and subtractive.

Basic color theory is an eight valued Bₛ algebra. In the additive model the presence of a primary color is a denial of the minimal value black. In the subtractive model primary colors are contrary properties. For both models a primary color is a property of white light. The lesson is generalised:

A primary value is a denial of the minimal zero, contrary to other primary values, and a property of the maximal value. (3.0)

Following 3.0, if the designated value of L₄ is interpreted as true, then the middle values 2 and 3 are properties of true and deny false. A class of contingent adjectives provides a solution e.g. (accidental, incidental, coincidental, marginal, temporary, extraneous, superfluous, etc.). This class preserves truth. For example, if a state of affairs is accidental it is contingent yet also true. When the class is joined, it is thus named C.

C=_{def} (4.0)
accidental or incidental or coincidental or
marginal or temporary or superfluous, . . . etc.

The series of negative conjunction N is named non-contingent.

N=_{def} (4.1)
not accidental and not incidental and not coincidental and
not marginal and not temporary and not superfluous, . . . etc.

There is a possible world counterpart to the natural language definitions. W₁ is the start world and W₂ some world accessible from W₁.

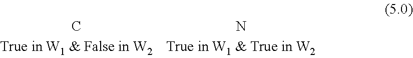

The set of values are false, contingent, non contingent, and true, viz., {F, C, N, T}. The basic non-modal and alethic propositions are defined as Table 6.

TABLE 6

| | p | ~p | □p | ~□p | ⋄p | ~⋄p | Np | Cp |
|---|---|---|---|---|---|---|---|---|
| p is the case | T | F | N | C | T | F | N | C |
| p is not the case | F | T | F | T | C | N | N | C |

If {0, 3, 2, 1} is replaced with the B₄ set {00, 10, 01, 11} there is an intuition that says extremes of necessity ought to be held farthest apart, i.e. (00 01)(p)=□p and (10 00)(p)=˜⋄p. This is named polarity. Polarity occurs if the ∇ functor applies to the positive case and the Δ functor to the negative case as Table 7.

TABLE 7

| | p | ~p | □p | ~□p | ⋄p | ~⋄p | |
|---|---|---|---|---|---|---|---|
| p is the case | 11 | 00 | 01 | 10 | 11 | 00 | +∇ |
| p is not the case | 00 | 11 | 00 | 11 | 01 | 10 | −Δ |

The set {F, C, N, T} proves an inconsistent interpretation of a polar system i.e. both 01 and 10 are interpreted as N. Alternative values are introduced as {(U) unevaluated, (I) improper, (P) proper, (E) evaluated}. The values I and P are a conditional access between worlds.

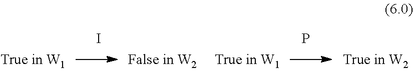

As a combined system {F, C, N, T} is Model 1 and {U, I, P, E} is Model 2. Table 8 makes clear how the B₄ set is interpreted in either model.

TABLE 8

| | | | |
|---|---|---|---|
| 11 | 1 | T | E |
| 01 | 2 | N | P |
| 10 | 3 | C | I |
| 00 | 4 | F | U |

Table 9 extends the interpretations of the non modal and propositions to both models.

TABLE 9

| | p | ~p | □p | ~□p | ⋄p | ~⋄p |
|---|---|---|---|---|---|---|
| p is the case | T, E | F, U | N, P | C, I | T, E | F, U |
| p is not the case | F, U | T, E | F, U | T, E | C, P | N, I |

In Model 2 the modal box is interpreted as correct and the lozenge as passable. Correct may mean unmistaken or appropriate.

A theorem in this two-tone variant of L₄ (VL₄) is valid in both models. Model 1 is equivalent to L₄ and harbors no further caveats. Model 2 qualifies Model 1, and so VL₄ theorems are a subset of L₄. Model 2 has additional technical framework because it is not clear which is the correct functor to apply when the number of propositions is greater than one. At such times middle rows of a table mix truth possibilities. Table 10 covers all of the available options.

TABLE 10
Three modal options for mixed truth possibilities

| □1 | □2 | □3 | ⋄1 | ⋄2 | ⋄3 |
|---|---|---|---|---|---|
| ×E | ×U | ×P, ×I | +U | +E | +I, +P |

On Table 10 option 1 is neutral, leaving the middle rows of a truth table unchanged. The box operator under option 2 returns U, the lozenge returns E. Option 3 evaluates twins functors separately. Given options 1 and 2, option 3 is redundant. Atomic formulae are unary and do not have a middle row. Hence the question of which option does not arise.

Along with many implausible theorems, Model 2 invalidates 2.0 as seen on Table 11.

TABLE 11

| ( [symbol] A | | [symbol] B) | | ⋄ | (A | | B) |
|---|---|---|---|---|---|---|---|
| [symbol] p | & | [symbol] q | → | Option 1 | p | & | q |
| PEPE | PEPE | EEEE | IIEE | UIPE | UIPE | UIPE | EEEE |
| PEPE | PEPE | EEEE | IUEP | UUPP | UIPE | UUPP | PPPP |
| PEPE | PPPP | PPPP | IIII | UIUI | UIPE | UIUI | IIII |
| PEPE | PPPP | PPPP | IIII | UUUU | UIPE | UUUU | UUUU |

The one instance on Table 11 where E→U means the inference is not a valid consequence in VL₄ (see Table 1). More controversial is Model 2 which finds against axiom K.

TABLE 12

| □ | | | | | (□A | | □B) |
|---|---|---|---|---|---|---|---|
| Option1 | (A | → | B) | → | Option1 | → | □q |
| EEEE | UIPE | EEEE | EEEE | EPEP | UIPE | EPEP | PPPP |
| EPEP | UIPE | EPEP | PPPP | EEEE | UIPE | EPEP | PPPP |
| EEII | UIPE | EEII | IIII | EPEP | UIPE | EPIU | UUUU |
| EPIU | UIPE | EPIU | UUUU | EEEE | UIPE | EPIU | UUUU |

As K is not controversial one should not expect conspicuous counter examples. However, on Table 12 the condition I→U is a cause for concern, viz., □(A→B) [symbol] (□A→□B).

Consider the following example first reading the modal box as ‘correct’: If correct that banking regulations imply egregious losses mount up, then, correct banking regulations imply it is correct egregious losses mount up. It may be correct the present state of regulation leads to egregious losses, but this does not mean correct regulation implies egregious losses.

Another example reads the modal box as necessity: If it is necessarily the case freewill implies sometimes a person abstains, then freewill is necessarily the case implies sometimes a person abstains is necessarily the case. If a person who never abstains entails the negation of freewill, then on that condition the antecedent is true. However, if the final consequent means sometimes abstinence is the only option then freewill is negated.

Referring again to Table 12 the inference fails where the consequent is unevaluated. The first example invokes regulation both ‘correct and egregious’ and the second example invokes an abstinence both ‘necessary and optional’. Both examples invite oxymora that make little sense and hence the validity of K as a structural inference is threatened.

The bivalent framework is not limited to L₄. One well known set of four valued matrices is Lewis and Langford's Groups I-V, from C. I. Lewis and H. C. Langford

Lewis, C. I., Langford, H. C., Symbolic Logic (Second Edition), New York: Dover Publications, 493-495, 1959, (“Lewis and Langford 1959”), herein incorporated by reference in its entirety for all purposes. Table 13 includes the necessity operator.

TABLE 13

| | I | | II | | III | | IV | | V | |
|---|---|---|---|---|---|---|---|---|---|---|
| | □ | ⋄ | □ | ⋄ | □ | ⋄ | □ | ⋄ | □ | ⋄ |
| 1 | 2 | 1 | 1 | 1 | 1 | 1 | 1 | 2 | 2 | 1 |
| 2 | 4 | 1 | 4 | 2 | 4 | 1 | 3 | 2 | 4 | 2 |
| 3 | 4 | 1 | 3 | 1 | 4 | 1 | 3 | 2 | 3 | 1 |
| 4 | 4 | 3 | 4 | 4 | 4 | 4 | 3 | 4 | 4 | 3 |

Group III lacks a twin and cannot be weakened. The other groups do have twins if the second designated value is switched when the negative case. This is problematic in as far as it is uncertain whether it is 2 or 3 that is designated where truth possibilities are mixed. With that caveat, groups I, II, IV and V may be weakened using the bivalent framework. For axiom K groups I, II and V have a set of conditions such that 2→4 or 3→4. For group IV there is the set of conditions 2→3 or 3→2. Despite uncertain designation these conditions ensure the inference is invalid. While Model 2 militates against Lewis' strict implication it is worth noting I and II preserve his amended postulates A1-A7 after weakening, but A8 is now invalid. However, Group V also originally failed to validate A8 (Lewis and Langford 1959).

General Strategy for Parsing Minimal Sets

The objective is to take any logic with Boolean operations (&) and (˜) and parse the minimal set of semantic elements. The minimal set is an intuitively easy concept to grasp. In color theory it is the set of primary colors, viz., {red, green, blue}. The set contains no subcontrary pair of elements, and no individual formula is a contradiction. In a formal language the minimal set has the maximal number of contrary elements expressible in the language. Suszko's Thesis is taken to mean “every logic is logically two valued” (Suszko 1977). The objective here is to give a zero-one evaluation of the minimal set.

The modal system S5 is examined. The S5 unary fragment is a simple B₄ algebra with four primary values, viz., (0001)(□p), (0010)(˜□p &p), (0100)(⋄p & −p), (1000)(˜⋄p).

As the unary fragment is a B₄ logic the starting point for binary formula is a 4×4 grid. Extended analysis proves a simple 4×4 grid is insufficient and the final grid is as Table 14.

TABLE 14

| 1 | 2 | | | | | 3 | | | | | 4 |
|---|---|---|---|---|---|---|---|---|---|---|---|
| 5 | 6 | 7 | 8 | 9 | 10 | 11 | 12 | 13 | 14 | 15 | 16 |
| 17 | 18 | 19 | 20 | 21 | 22 | 23 | 24 | 25 | 26 | 27 | 28 |

| | | | |
|---|---|---|---|
| 29 | 30 | 31 | 32 |

All 32 primary values are accounted for in Table 15. The number corresponds to their location on the grid. These formula whilst syntactically complex are the S5 semantic atoms (primary colors).

TABLE 15
The minimal set for S5 has 32 primary values.

| | |
|---|---|
| 1. | □p & □~q |
| 2. | □p & ⋄q & ~q |
| 3. | □p & q & ⋄~q |
| 4. | □p & □q |
| 5. | p & ⋄~p & □~q |
| 6. | □(q → p) & p & ⋄~p & ⋄q & ~q |
| 7. | (□(p v q) v □(~p v ~q)) & ⋄(p & q) & p & ⋄~p & ⋄q & ~q |
| 8. | (□(p v q) v □(~p v ~q)) & ⋄(~p & ~q) & p & ⋄~p & ⋄q & ~q |
| 9. | □(p v q) & □(~p v ~q) & p & ⋄~p & ⋄q & ~q |
| 10. | (⋄(~p & q) [symbol] ⋄(p & q)) & ⋄(~p & ~q) & p & ⋄~p & ⋄q & ~q |
| 11. | □(p v q) & p & ⋄~p & ⋄~q & q |
| 12. | (□(p v ~q) v □(~p v q)) & ⋄(~p & q) & p & ⋄~p & ⋄~q & q |
| 13. | (□(p v ~q) v □(~p v q)) & ⋄(p & ~q) & p & ⋄~p & ⋄~q & q |
| 14. | □(p v ~q) & □(~p v q) & p & ⋄~p & ⋄~q & q |
| 15. | (⋄(~p & ~q) [symbol] ⋄(p & ~q)) & ⋄(~p & q) & p & ⋄~p & ⋄~q & q |
| 16. | □q & p & ⋄~p |
| 17. | ⋄p & □~q & ~p |
| 18. | □(~p v ~q) & ~p & ⋄p & ⋄q & ~q |
| 19. | (□(p v ~q) v □(~p v q)) & ⋄(~p & q) & ~p & ⋄p & ⋄q & ~q |
| 20. | (□(p v ~q) v □(~p v q)) & ⋄(p & ~q) & ~p & ⋄p & ⋄q& ~q |
| 21. | □(p v ~q) & □(~p v q) & ~p & ⋄p & ⋄q & ~q |
| 22. | (⋄(p & q) [symbol] ⋄(p & ~q)) & ⋄(~p & q) & ~p & ⋄p & ⋄q& ~q |
| 23. | □(p → q) & ~p & ⋄p & ⋄q & q |
| 24. | (□(p v q) v □(~p v ~q)) & ⋄(p & q) & ~p & ⋄p & ⋄~q& q |
| 25. | (□(p v q) v □(~p v ~q)) & ⋄(~p & ~q) & ~p & ⋄p & ⋄~q & q |
| 26. | □(p v q) & □(~p v ~q) & ~p & ⋄p & ⋄~q & q |
| 27. | (⋄(p & ~q) [symbol] ⋄(p &q)) & ⋄(~p & ~q) & ~p & ⋄p & ⋄~q & q |
| 28. | □q & ⋄p & ~p |
| 29. | □~p & □~q |
| 30. | □~p & ~q & ⋄q |
| 31. | □~p & q & ⋄~q |
| 32. | □~p & □q |

The 32 primary values form a grid. However, the extra five formulae of the four central cells on Table 15 require additional 4×4 grids that qualify the formula as Table 16.

TABLE 16

| a | | | | | b | | | | |
|---|---|---|---|---|---|---|---|---|---|
| 6 | 7 | 8 | 9 | 10 | 11 | 12 | 13 | 14 | 15 |
| 1100 | 0010 | 0000 | 0001 | 0000 | 0011 | 0100 | 0000 | 1000 | 0000 |
| 1100 | 0011 | 0000 | 0000 | 0000 | 0011 | 1100 | 0000 | 0000 | 0000 |
| 0000 | 0000 | 1100 | 0000 | 0011 | 0000 | 0000 | 0011 | 0000 | 1100 |
| 0001 | 0000 | 0100 | 1000 | 0010 | 1000 | 0000 | 0010 | 0001 | 0100 |
| c | | | | | d | | | | |
| 18 | 19 | 20 | 21 | 22 | 23 | 24 | 25 | 26 | 27 |
| 0001 | 0100 | 0000 | 1000 | 0010 | 1000 | 0000 | 0010 | 0001 | 0100 |
| 0000 | 1100 | 0000 | 0000 | 0011 | 0000 | 0000 | 0011 | 0000 | 1100 |
| 1100 | 0000 | 0011 | 0000 | 0000 | 0011 | 1100 | 0000 | 0000 | 0000 |
| 1100 | 0000 | 0010 | 0001 | 0000 | 0011 | 0100 | 0000 | 1000 | 0000 |

Table 17 is a limited selection of binary grids sufficient for modeling S5's binary fragment. Formulae in which the scope of the modal operators extends to two variables incorporate grids a, b, c, d from Table 16, or their negations.

TABLE 17

| 1 | 2 | 3 | 4 | 5 | 6 | 7 |
|---|---|---|---|---|---|---|
| □p | p | [symbol] p | □q | q | [symbol] q | □(q → p) |
| 1111 | 1111 | 1111 | 0001 | 0011 | 0111 | 1111 |
| 0000 | 1111 | 1111 | 0001 | 0011 | 0111 | 0aa1 |
| 0000 | 0000 | 1111 | 0001 | 0011 | 0111 | 00a1 |
| 0000 | 0000 | 0000 | 0001 | 0011 | 0111 | 0001 |
| 8 | 9 | 10 | 11 | 12 | 13 | 14 |
| □(p v q) | □(p → ~q) | □(p → q) | [symbol] (~p & ~q) | [symbol] (q & ~p) | [symbol] (p & q) | □(q → p) |
| 1111 | 1000 | 0001 | 0000 | 0000 | 0111 | 1111 |
| 1bb0 | 1c00 | 00d1 | 1aa0 | 0bb1 | 0c11 | 11d0 |
| 1b00 | 1cc0 | 0dd1 | 11a0 | 0b11 | 0cc1 | 1dd0 |
| 1000 | 1111 | 1111 | 1110 | 0111 | 0000 | 0000 |

The system of truth functional grids expands with each new variable considered. Hence the values are enumerable but potentially infinite. This point means a truth functional S5 complies with the result of James Dugundji, Note on a property of matrices for Lewis and Langford's calculi of propositions. The Journal of Symbolic Logic, 5 (4), 150-151, 1940 (“Dungundji 1940”), herein incorporated by reference in its entirety for all purposes, that establishes S1-S5 to have no finite matrix.

S5 is a normal modal logic with axiom K, but there is reason to doubt K. A similar logic to S5 retains the basic grids 1-6 but additionally qualifies grids 7-14 in Table 18.

TABLE 18
10*
□(p → q)
00d1
00d1
ddd1
1111

Grid 10* belongs to a system that invalidates K.

Summary Remarks

While the bivalent framework is a model to weaken a class of logics with twin functors, VL4 is also capable of testing a range of well known many-valued logics through the logic model checker in the next part. Significantly, VL4 can approach different logics as alternative classes of minimal sets and test practical examples of logics that comply to Suszko's Thesis (Suszko 1977).

The range of testable logics include three-valued and four-valued logic systems.

The ternary, three-valued logics include: Kurt Gödel, Zum intuitionischen Aussagenkalkül. Anzeiger der Akademie der Wissenschaften in Wien 69, 65-66, 1932 (“Gödel 1932”); Sören Halldén, The logic of nonsense, Uppsala University, Uppsala, 1949 (“Halldén 1949”); S. C. Kleene, On a notation for ordinal numbers, The Journal of Symbolic Logic, 50-155, 1938 (“Kleene 1938”); S. C. Kleene, Introduction to Metamathematics. D. Van Nostrand, Princeton, N.J., 1950 (“Kleene 1950”); Jan Lukasiewicz, On Three-valued Logic, in L. Borkowski (ed.), Amsterdam, North-Holland, 1970, 87-88, 1920 (“Lukasiewicz 1920”); Graham Priest, The Logic of Paradox. Journal of Philosophical Logic, Vol. 8, No. 1, January, 219-241, 1979 (“Priest 1979”); all herein incorporated by reference in their entirety for all purposes.

The quaternary, four-valued logics include: N. D. Belnap, A useful four-valued logic, in J. M. Dunn, G. Epstein (eds.), Modern Uses of Multiple-Valued Logic, Dordrecht: Reidel, 8-37, 1977 (“Belnap 1977”); Béziau 2011; (Lewis and Langford 1959; Kleene 1950; (Lukasiewicz 1953); Nicholas Rescher, An intuitive interpretation of systems of four-valued logic, Notre Dame Journal of Formal Logic, Volume VI, Number 2, April, 154-156, 1965 (“Rescher 1965”); all herein incorporated by reference in their entirety for all purposes.

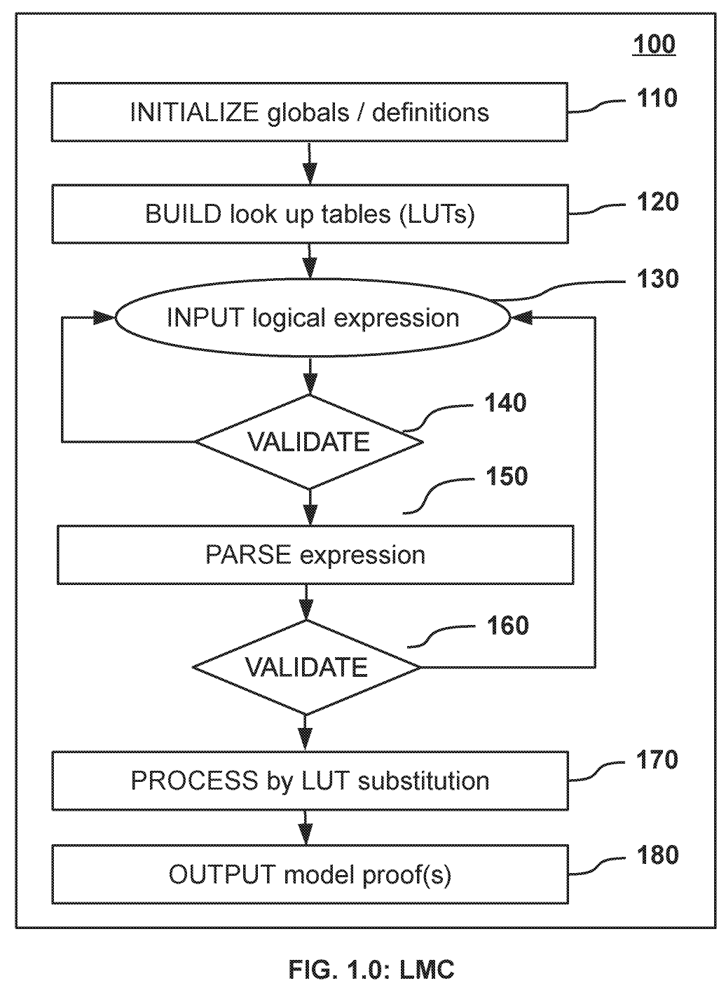

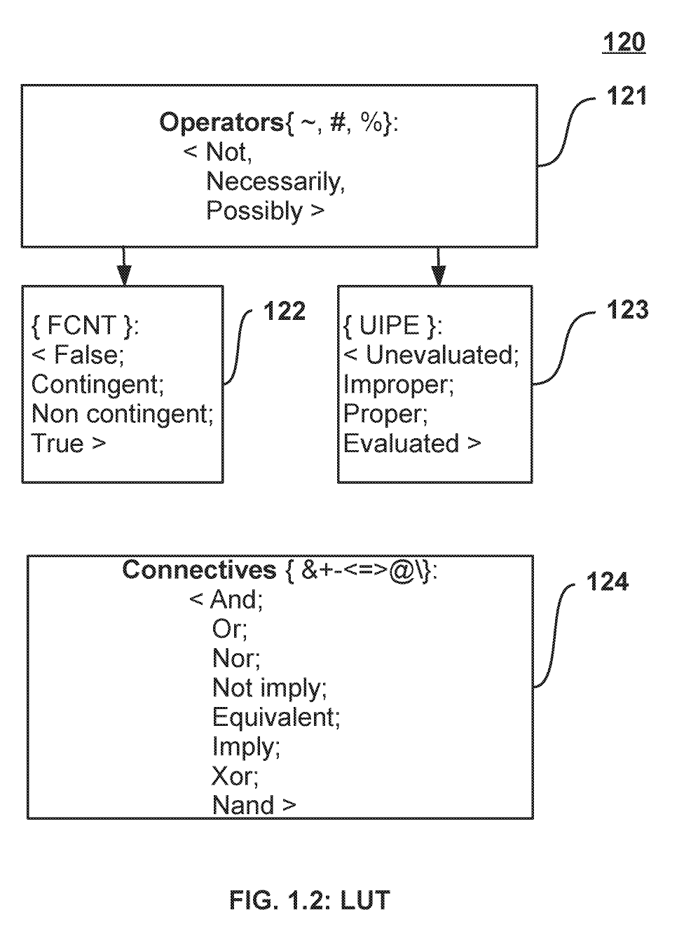

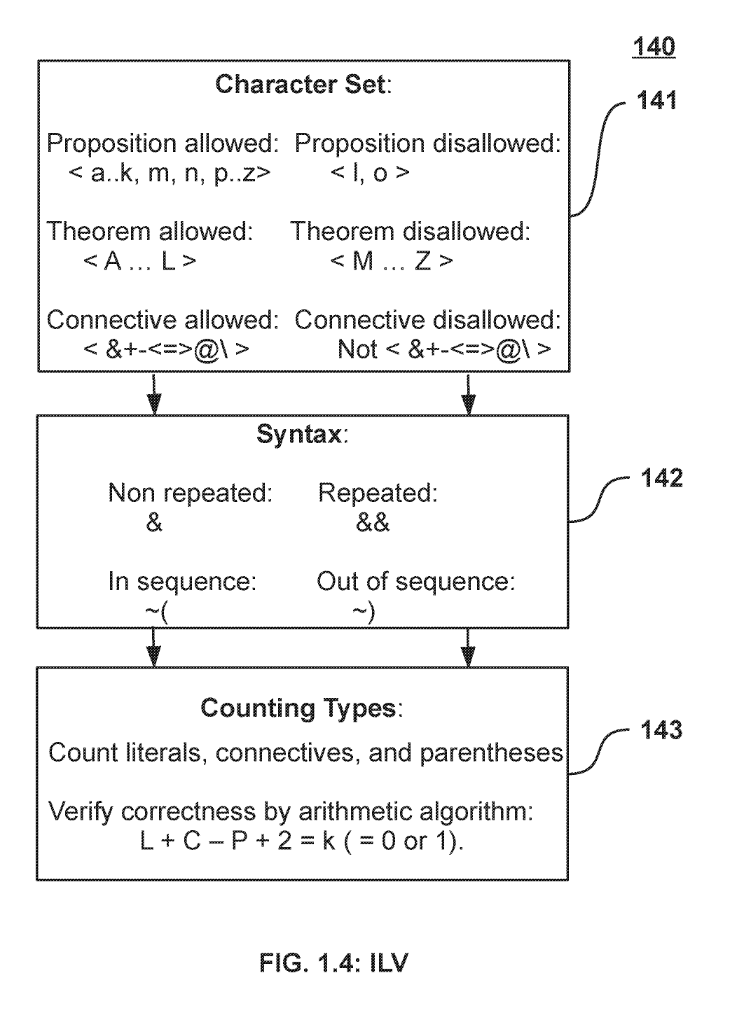

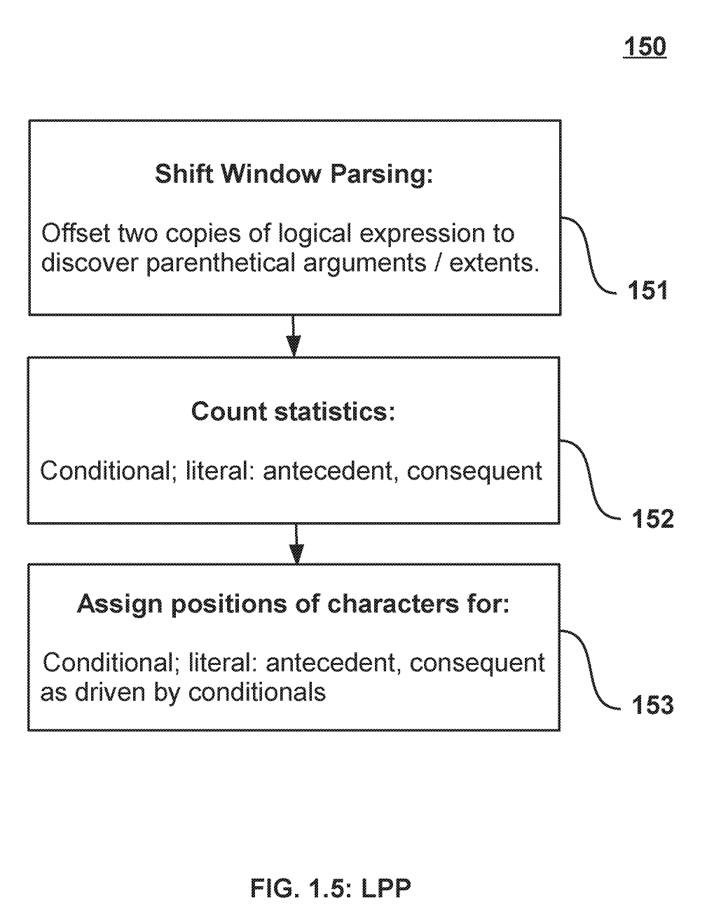

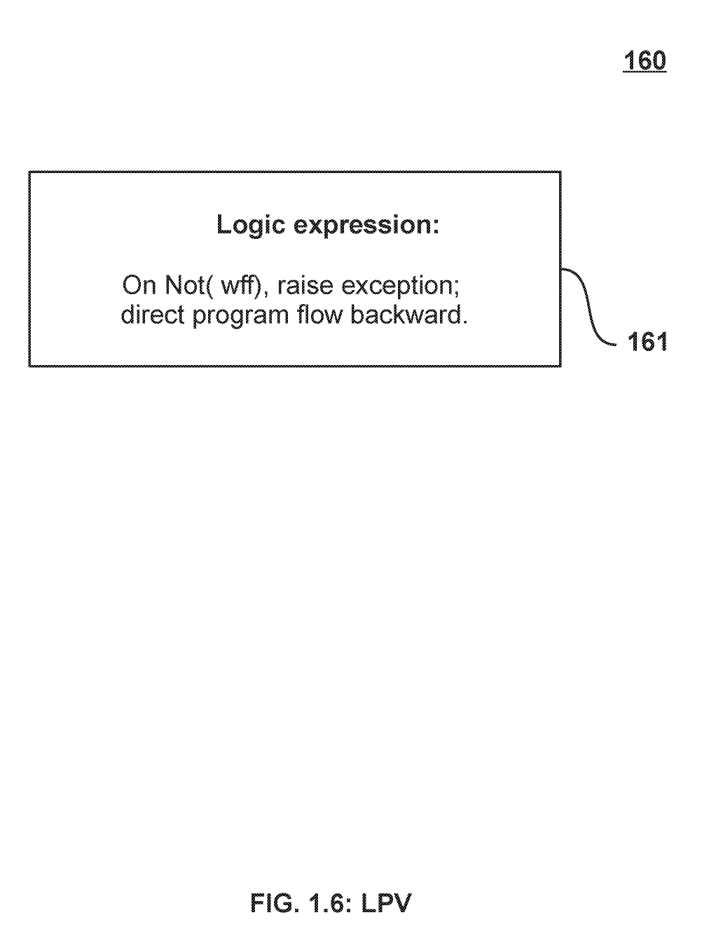

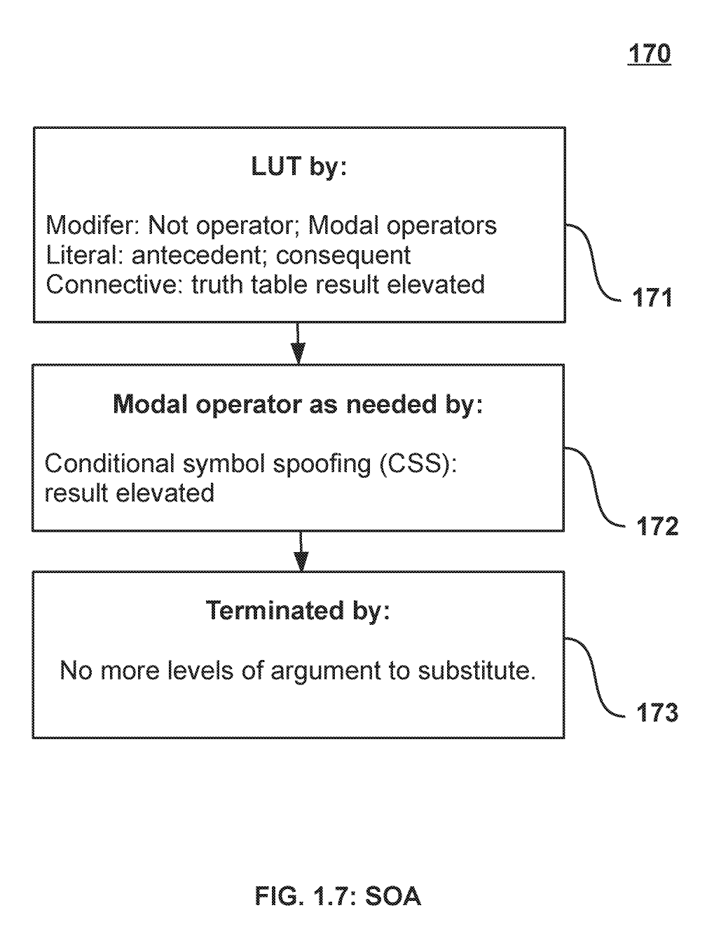

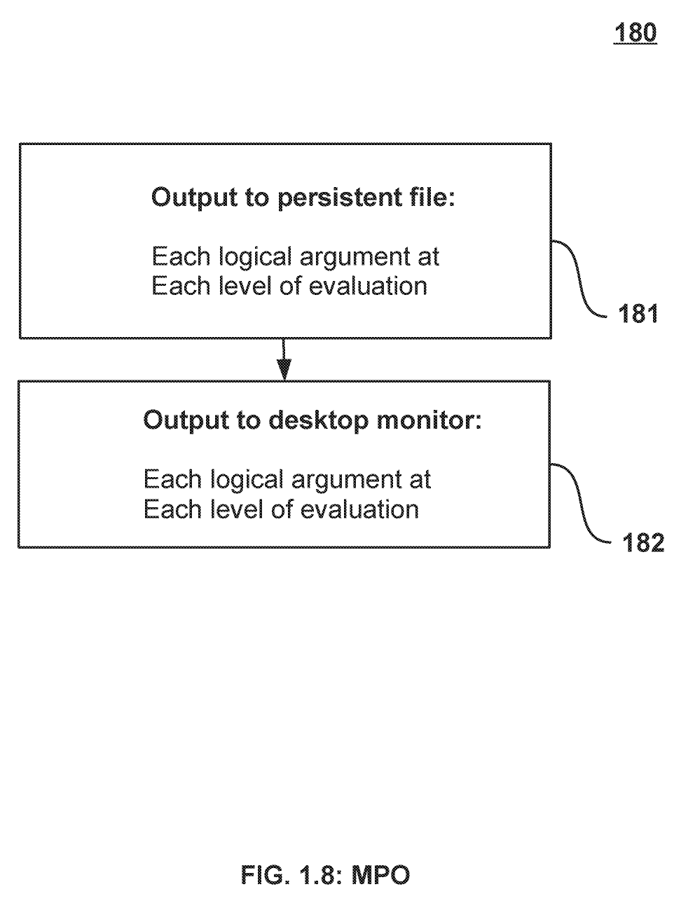

For the logic model checker LMC, all aspects of figures and steps are keyed to the FIG. 1.0 series of Steps 100-182.

Meth8 Model Prover

The logic model checker LMC named Meth8 stands for Mechanical theorem prover in 8-bits. It is a model prover for modal logic using the rules of VL4 the part above. The prover is driven by look up tables (LUT) with calculation for intermediate results. The purpose of Meth8 is to invalidate models of the logic system tested.

The development language used is TrueBASIC®, an ANSI standard for educators. The source code is directly portable for embedded systems into VHDL (a subset of Ada 95) as for example in Colin James III, U.S. Pat. No. 9,202,166, Method and system for Kanban cell neuron network, Appendix, Dec. 1, 2015. (“James 2015b”), herein incorporated by reference in its entirety for all purposes.

Programming constraints on large memory limit the number of literal variables to 24 propositions or 12 theorems. The propositions are named as the 24 lower case letters from a to z, but excluding the lower case letter of “l”, as in lion, and lower case letter “o” as in ocean because they are easily confused with the ordinal digits of one and zero. The theorems are named as the 12 upper case letters from A to L. The operators supported are the modal box and lozenge, and negation here given in one character symbols as {#, %, ˜}. The eight connectives supported are conjunction, disjunction, joint denial, converse implication, biconditional, implication, exclusive disjunction, and alternative denial in one character symbols as {&+−<=>@\}. The maximum number of characters in an input expression is 2̂30 (1 B).

The model prover consists of three parts for parser, processor, prover as named with the acronym of p-cubed or P³.

Parser

The parser component requests input from the user for the logic system and parameter directives unique to that logic system and is stored in a file at the root directory. The parser requests input of an expression to be processed. It is checked for syntax compliance and semantic content. The syntax includes correct symbols within the allowed character sets for literal types, literal operators, and connectives. The semantic content includes: the order of operators, literals, and connectives; and the nesting of parentheses for argument. Sequential combinations of modal operators and negation to literals are automatically reduced to the minimal algebraic state. A novel approach to mapping matched parentheses uses the unique sliding window parser named SWP.

A work worked example of the SWP with source code is below:

The input example is a well-formed formula (wff) within an outer pair of parentheses as sentinel markers.

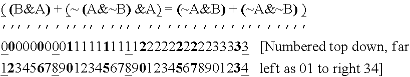

The goal is to parse the input into nested arguments enclosed in pairs of parentheses

Step 1: Read the input to mark each parenthetical position as Right “)” or Left “(”.

| | |
|---|---|
| Position | 000011122233 |
| | 126805805734 |
| Left/right paren | LLRLLRRLRLRR |
| Shift window left | LLRLLRRLRLRR |
| Position | 000011122233 |
| | 126805805734 |

Step 2: Build extent table with extent size of arguments according to these rules*. * Source code in True BASIC follows for the logical rules, presented as a teaching tool. Numeric arrays are used, but string variables can also be concatenated as lists instead of indexing into string arrays. The number of passes through the input expression is linear as the stack_size plus one pass to index parenthesis back into the input expression: here 12+1=13 passes.

| Index | Extent | Size | Argument pointer by position | | | |
|---|---|---|---|---|---|---|
| 1 | 02 . . 06 | 5 | (B&A) | | | |
| 2 | 10 . . 15 | 6 | | (A&~B) | | |
| 3 | 20 . . 25 | 6 | | | (~A&B) | |
| 4 | 27 . . 33 | 7 | | | | (~A&~B) |
| 5 | 08 . . 18 | 11 | | (~ (A&~B) &A) | | |

| | | | |
|---|---|---|---|
| 6 | 01 . . 34 | 34 | ( (B&A) + (~ (A&~B) &A) = |
| | | | (~A&B) + (~A&~B) ) |

Step 3: Evaluate arguments by smaller character extents then substitute into larger character extents; (A&˜B) is processed before substitution back into (˜(A&˜B) &A).

A subsequent task is the evaluation of grouped arguments as tokens of logical symbols. From the argument layout in Step 3, the conditional serves as a pivot point to demarcate arguments taken as an antecedent and as a consequent. From the indexed arguments, the position of the conditional is derived by arithmetic where position 06+01=07 as “+”, position 18+01=19 as “=”, and position 25+01=26 as “&”. The atomic arguments such as (A&˜B) and then ˜(A&˜B) are evaluated directly by lookup table (LUT) in VL4.

LIBRARY ″StrLib.trc″
DECLARE DEF KeepChar$

| | |
|---|---|
| LET ruler$ | ″′′′′′′′′′′′′′′′′′′′′′′′′′′′′′′′′′′′′′′′′′′′″ |
| LET scale_01$ | = ″0000000001111111111222222222233333333334444″ |
| LET scale_02$ | = ″1234567890123456789012345678901234567890123″ |
| ! LET test_inp$ | = ″((B&A)+(~(A&~B)&A)=(A+(~A+(A&B)))+(~A&~B))″ |
| LET test_inp$ | = ((B&A)+(~A&~B)&A)=(~A&B)+(~A&~B)) |
| ! LET parentheses$ | = ″LLRLLRRLLLRRRLRR″ |
| LET parentheses$ | = ″LLRLLRRLRLRR″ |
| LET left_prn$ | = ″(″ |
| LET rght_prn$ | = ″)″ |
| LET left_prn | = 1 |
| LET rght_prn | = 2 |
| LET prn_sym_num | = 2 |
| LET len_test_inp | = LEN( test_inp$) ! keep parens in line below |
| LET prn_test_inp$ | = KeepChar$( test_inp$, left_prn$ & rght_prn$) |
| LET stack_size | = LEN( prn_test_inp$) |
| LET extent_size | = stack_size / 2 |

DIM extent ( 0, 0)
MAT REDIM ( extent extent_size, prn_sym_num)
DIM position ( 0, 0)
MAT REDIM position ( stack_size, prn_sym_num) ! left_prn=1, rght_prn=2

| | |
|---|---|
| MAT position | = 0 |

```
PRINT
PRINT test_inp$
PRINT ruler$
PRINT scale_01$
PRINT scale_02$
PRINT
PRINT parentheses$
PRINT
PRINT ″Extent pair″, ″Left paren″, ″Right paren″, ″Extent size″
FOR idx = 1 TO len_test_inp  ! Get position( ) for L, R
    LET test_prn$ = test_inp$[ idx: idx]
  IF test_prn$ = left_prn$ THEN  ! ″L″ left
      LET position_count = position _count + 1
      LET position( position_count, left_prn) = idx
  ELSE IF test_prn$ = rqht_prn$ THEN  ! ″R″ right
      LET position_count = position _count + 1
      LET position( position_count, rght_prn) = idx
  END IF
NEXT idx
LET extent_idx = 0
FOR outer_idx = 1 TO stack_size
  FOR kdx = 2 TO stack_size ! Shift rght_prn upward (or to the left)
        LET mdx = kdx - 1
        LET position( mdx, rght_prn) = position( kdx, rght_prn)
  NEXT kdx
  FOR mdx = 1 TO stack_size
        IF position( mdx, left_prn) > 0 AND position( mdx, rght_prn) > 0
        THEN
```

| | |
|---|---|
| LET extent_idx | = extent_idx + 1 |
| LET extent( extent_idx, left_prn) | = position( mdx, left_prn) |
| LET extent( extent_idx, rght_prn) | = position( mdx, rght_prn) |

```
          LET extent_size = 1 + position( mdx, rght_prn)
              − position( mdx, left_prn)
          PRINT extent_idx, extent( extent_idx, left_prn),
            extent( extent_idx, rght_prn), extent_size
          LET position( mdx, left_prn)  = 0
          LET position ( mdx, rght_prn) = 0
        END IF
  NEXT mdx
NEXT outer_idx
PRINT ″  Pausing  ...  ″;
GET KEY key_zzz
STOP
END
```

Processor

A LUT is based on three sources of data to populate it: 1. External files; 2. Data statements; and 3. Algorithmic calculation. Data read from external files is best suited in a small memory footprint of LUT such as implementation in programmable hardware parts for speed. Software programs use self-contained data statements to build a LUT in a larger memory space such as for desktop computing. Building a LUT by calculation as needed on the fly is for hand held and portable devices such as tablets and cellphones. The software program relies on internal calculation and data statements to build a LUT.

Two models are supported with optional variants named: M1; M2.1; M2.2; and M2.3. From Tab. 8 above, M1 is for propositions with the default quaternary logic of {F, C, N, T}; and M2.1, 2.2, 2.3 is for theorems with the quaternary logic of {U, I, P, E}.

The processor implements the rules of VL4 in six steps to build and calculate tables:

1. Read logical value equivalents and negations by model options:
False=Unapplied=00=0; [Not:] True=Evaluated=11=1.

2. Read logical value modal conversions by model:
(F) (U): FC UU EU UP UI; . . . ; (TXE): NT EE UE IE PE.

3. Read logical value connective truth table rows by model:
&FCNT, FFFFF, CFCUC, NFUNN, TFCNT.

4. Read algebraic form of 4096 combinations for antecedent, conditional, and consequent as literal propositions, theorems, and connectives:
˜s & ˜p; ˜D & ˜A.

5. Calculate atomic propositions and theorems as logical values:
for two propositions, p=FTFT and q=FFTT;
for one theorem A=FCNT.

6. Calculate algebraic antecedent, conditional, and consequent into logic values for model options: for three propositions, ˜r & ˜q becomes

˜(FFFFTTTT) & ˜(FFTTFFTT)=(TTFFFFFF).

Step 6 uses a LUT from each of steps 1-4 in order, with a result in the form of successive rows of a truth table. (Step 1 is useful in compact systems for translating the same truth tables from Model 1 to Model 2.x.) The parsed input expression of interest is processed in respective iterations of the three subsequent steps:

7. An argument result as a truth table is stored from step 6 in the parse tree as the truth table of an intermediate result.

8. Intermediate results from step 7 are assigned as antecedent and consequent to a conditional in the LUT of connectives in step 3. Each respective logic value in the argument is evaluated to produce another intermediate result as a truth table and stored back into the parse tree.

9. When a truth table of the final result is obtained, the constituent intermediate truth tables are retrieved from the parse tree to build a final truth table record of the logical value transactions. The format is that of which Tab. 11 and Tab. 12 in the first part are a fragment.

Prover

The prover component evaluates the final truth table record for invalidation by model of the input expression. The final truth table record and invalidation by model is printed to the user screen and to an evaluation file.

Three examples of the output to an evaluation file are disclosed here.

In all examples a model proof is validated as based on the designated values T and E in the logical values of FCNT (False, Contingent, Non contingent, True) and UIPE (Unevaluated, Improper, Permissible, Evaluated).

Example 1 in Table 19 shows a grid portion for one row of truth table output. The input is for theorems A, B, C, D with [ ] as Necessarily and = as Equivalent as: (A&[ ]B)=(D&C).

TABLE 19

| Model 1 | Model 2.1 | Model 2.2 | Model 2.3.1 | Model 2.3.2 |
|---|---|---|---|---|
| TTTT | EEEE | EEEE | EEEE | EEEE |
| TTTT | EPEP | EEEE | EPEP | EEEE |
| TTCC | EEII | EEEE | EEEE | EEII |
| TTCC | EPIU | EEEE | EPEP | EEII |

Of the five models, Model 2.2 is validated as a proof of the logical expression with Evaluated. Example 2 in Table 20 shows a grid portion for one row of truth table output. The input is for the propositions p, q, r, s with [ ] as Necessarily, = as Equivalent, + as Or, and > as Imply as: ((p=q) & ˜[ ](p=(q+r)))>(p=(q+p)).

TABLE 20

| Model 1 | Model 2.1 | Model 2.2 | Model 2.3.1 | Model 2.3.2 |
|---|---|---|---|---|
| TTTT | EEEE | EEEE | EEEE | EEEE |
| TTTT | EEEE | EEEE | EEEE | EEEE |

All five models are validated as a proof of the logical expression with True and Evaluated.

Example 3 in Table 21 shows a grid portion for results of the GL, H, and W modal systems by proposition for [ ]([ ]p>p)>[ ]p and by theorem for [ ]([ ]A>A)>[ ]A:

TABLE 21

| | Model | Model | Model | Model | Model |
|---|---|---|---|---|---|
| Expression | 1 | 2.1 | 2.2 | 2.3.1 | 2.3.2 |
| □(□P>P)>□p | CTCT | UEUE | EEEE | PEPE | IIEE |
| | CTCT | UEUE | EEEE | PEPE | IIEE |
| □(□A>A)>□A | CCTT | UIPE | EEEE | PEPE | IIEE |
| | CCTT | UIPE | EEEE | PEPE | IIEE |
| | CCTT | UIPE | EEEE | PEPE | IIEE |
| | CCTT | UIPE | EEEE | PEPE | IIEE |

Modal logic GL means the Gödel-Löb axiom which forms the basis of Zermelo-Fraenkel set theory (ZF), with the axiom of choice (ZFC), as the basis of 20th century mathematics.

With p as “choice”, GL means:
“The necessity of choice, as always implying a choice, implies the necessity of choice.” VL₄ validates GL in one of five models. Because all five models do not validate the axiom with True and Evaluated, as in Example 2 Table 20, GL is not validated and hence invalidated. What GL would like to be, but cannot as written above, is [ ]([ ]p>p)>[ ](p+˜p), that is:
“The necessity of choice, as always implying a choice, implies the necessity of a choice or not a choice.”

In fact, that expression can be rewritten as [ ]([ ]p>p)=[ ](p+˜p), that is:
“The necessity of choice, as always implying a choice, is equivalent to the necessity of a choice or not a choice.”

Both of these reinventions of GL are validated by all models of VL₄.

The following list shows standardized modal logics by abbreviations which are not validated by VL₄ and by the partially validating model, with L as Necessarily and M as Possibly:

| | | |
|---|---|---|
| D1: | L(Lp>q) + L(Lq>p,); | Model 2.1 |
| F: | Lp=Mp; | Model 2.1 |
| F: | (LMp&LMq)>M(p&q); | Model 2.1 |
| F1: | ~M((p&q) & ~p); | Model 2.1 |
| F2: | ~M((p&q) & ~(q&p); | Model 2.1 |
| F3: | ~M((p&q)&r) & ~(p&(q&r)); | Model 2.1 |
| F4: | ~M(p & ~(p&q)); | Model 2.1 |
| F5: | ~M((~M(p&~q)&~M(q&~r)) & | Model 2.1 |
| | ~ ~M(p&~r)); | |
| GL, H,W: | L(Lp>p)>Lp; | Model 2.2 |
| HCR1: | MLp>(p>Lp); | Model 2.1 |
| MP: | Mp; | Model 2.2 |
| MS: | LMp > MLp; | Model 2.1 |
| Ver: | Lp; | no Model; |
| | | hence |
| | | declared false |
| Z1: | ~M(p & ~(p&p)); | Model 2.1 |
| Z2: | ~M((p&q)&~q); | Model 2.1 |
| Z3: | ~M(((r&p)&~(q&r))&~(p&~q)); | Model 2.1 |

This list shows how effective VL₄ is at invaliding standardized modal logics.

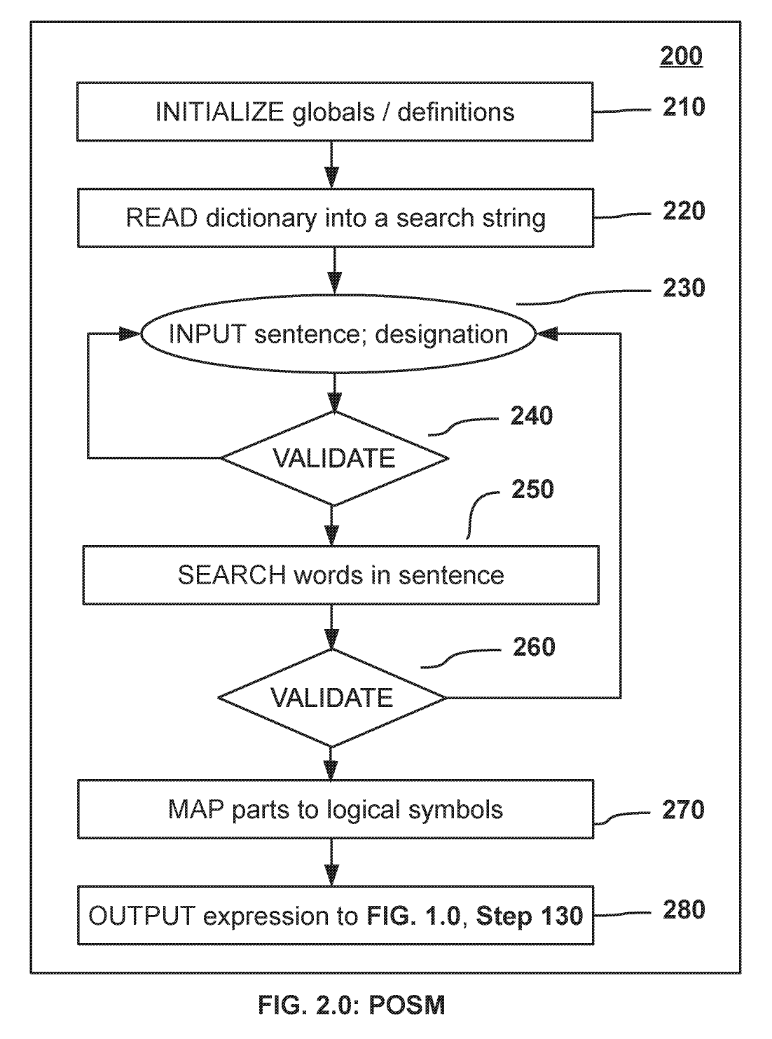

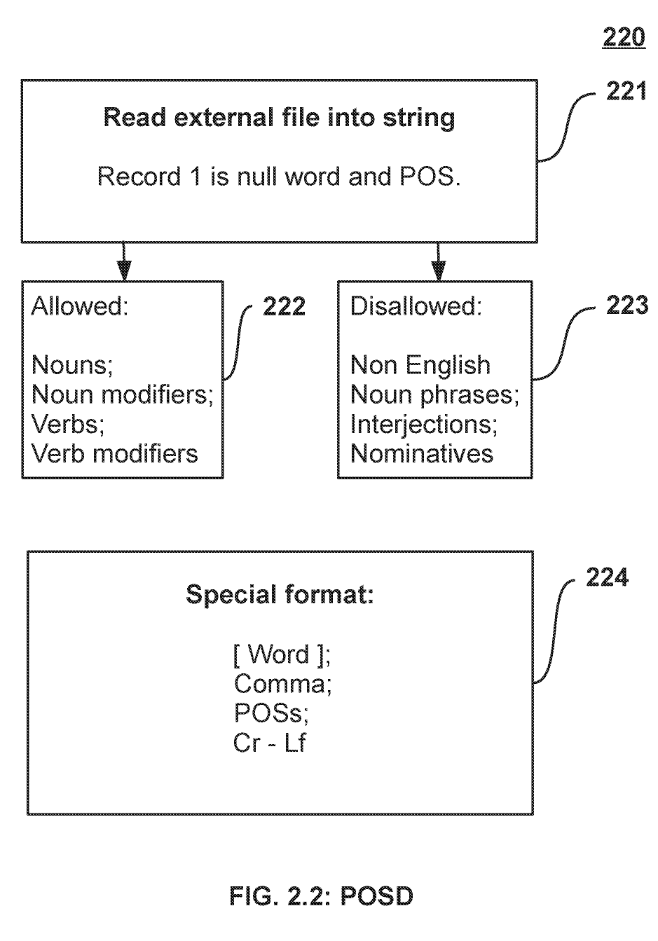

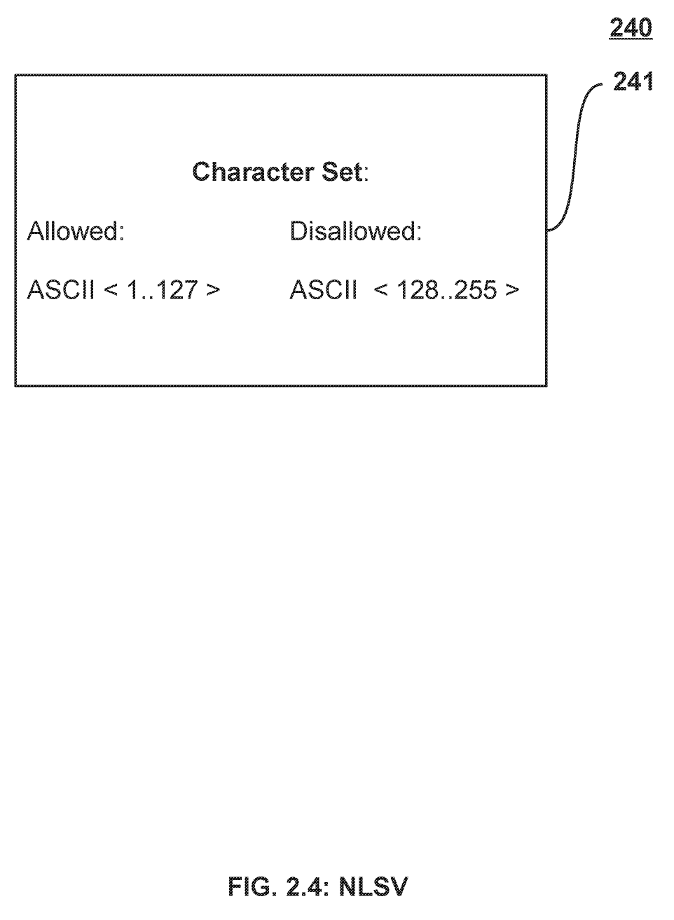

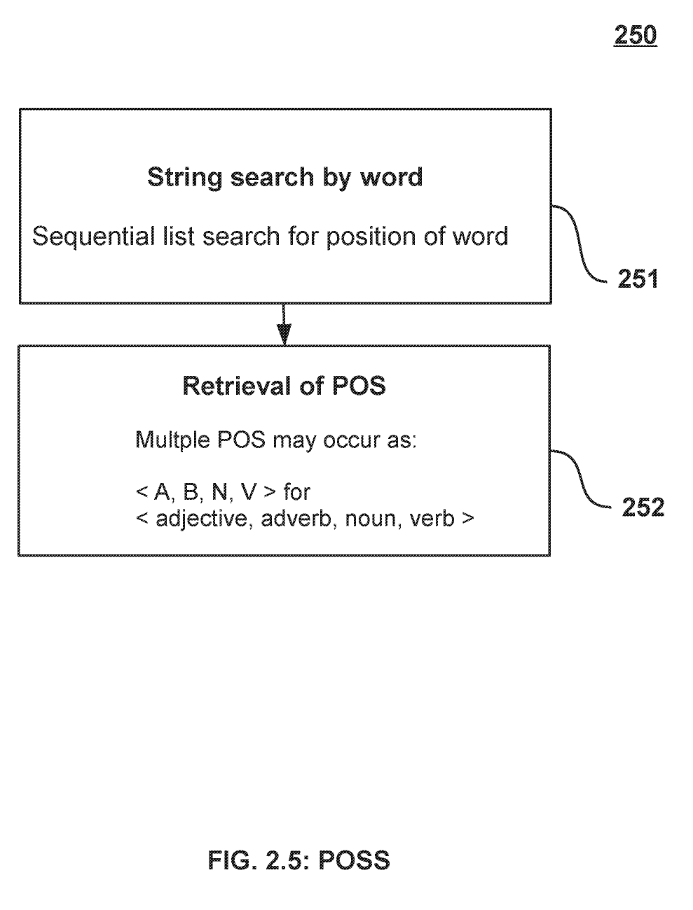

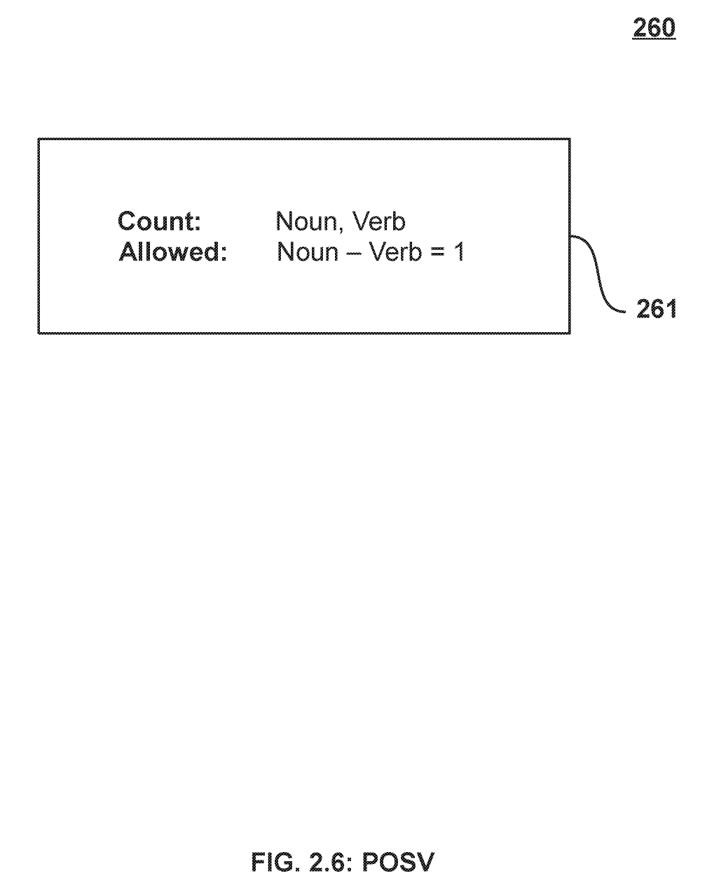

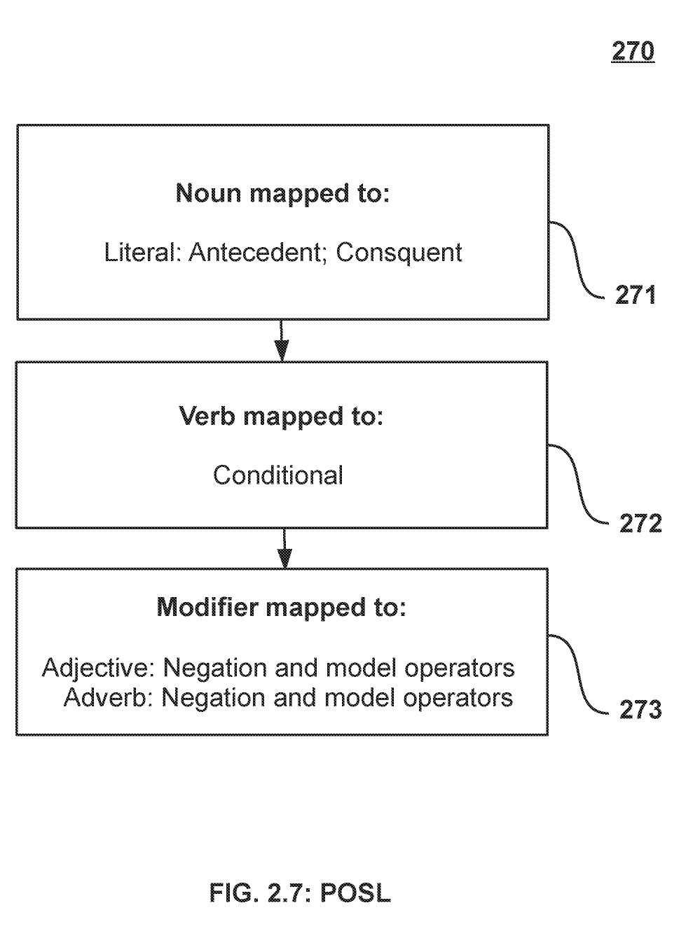

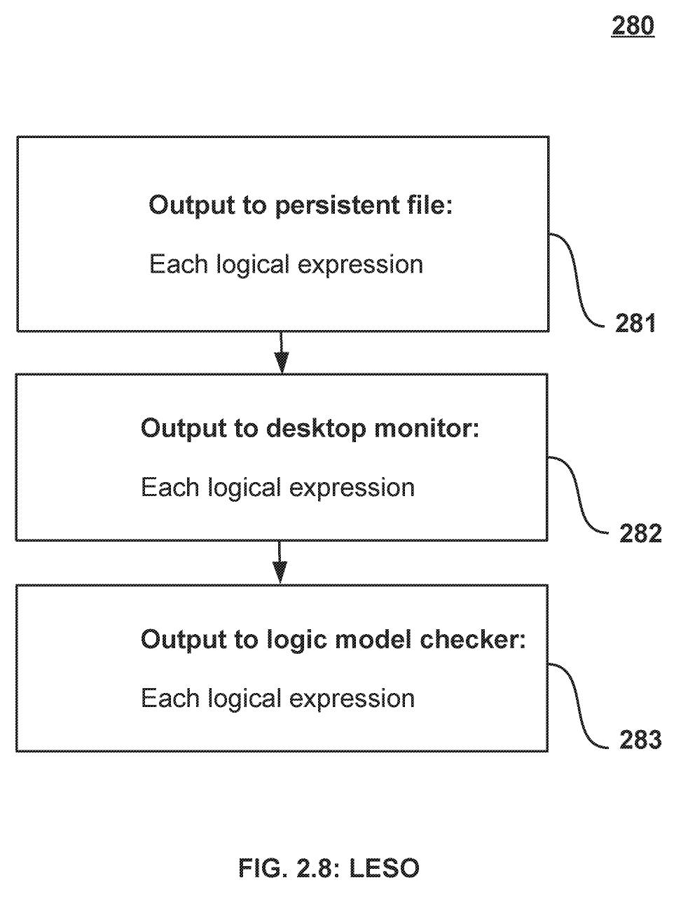

For the parts of speech mapper POSM, all aspects of figures and steps are keyed to the FIG. 2.0 series of Steps 200-283.

Assignment Strategy

For sentences, the parts of speech are decomposed as noun, noun modifier, verb, and verb modifier. The classification of the parts of speech is minimal. The types of noun are not distinguished, and the grammatical distinction of subject or object is not used. The types of verbs are ignored. The types of adjectives and adverbs are in parallel.

For sentence parsing, the parts of speech are assigned as follows: the noun phrases are theorems (or propositions); and the verb phrases are connectives. The adjectives are the NOT operator and the modal modifiers as necessary and possible. The adverbs are the NOT operator and the modal modifiers as necessarily and possibly. A sentence as composed of nouns, adjectives, verbs, and adverbs is mapped into logical symbols to form a logical expression. The logical symbols used are:

| | |
|---|---|
| Nouns: theorems | {A, B, C, D}; |
| propositions | {p, q, r, s} |
| Verbs : connectives | {&+−<=>@\} for |
| | {and, or, nor, not imply, equivalent, imply, xor, nand} |
| Adjectives: | {~#%} for |
| | {not, necessary, possible} |
| Adverbs: | {~#%} for |
| | {not, necessarily, possibly} |

The result is to validate the expression as proved or not proved, and by which models.

The manual steps of the assignment process appear in examples for the decomposition of a requirement sentence and of a programming structure.

Mapping Components

The next phase is to automate the mapping of language components to logical expressions for sentences, groups of sentences into paragraphs, and groups of paragraphs into the requirements document.

For parts of speech a dictionary look up table (LUT) is used and indexed by word. The list of words in the dictionary was taken from a public domain source. The list is modified for use by the automation tool of Meth8 named Meth8LUT. The dictionary has four parts of speech as noun, verb, adjective, and adverb. A word may have multiple parts of speech for the context of usage. The noun includes the forms of singular, plural, pronoun, and noun phrases. The verb includes the forms of intransitive, transitive, participle, gerund, and conjunction. The adjective includes the forms of preposition and definite and indefinite article. For the adjective or adverb, three logical states are mapped respectively as: not or never; necessary or necessarily; and possible or possibly. The list does not include interjections and nominatives.

(The grouping of a conjunction as a verb speaks to the verbally active quality of the word “and” to mean “combined with” or “multiplied by”, and the verbal active quality of the word “or” to mean “alternative to” or “in addition to”. Hence the conjunctions “and”, “or”, and “imply” act as verbs that map to those same logical connectives.)

The mechanism to search by word takes a novel approach. The dictionary is processed as a 2.5 MB string. The character format of a dictionary record is a word, comma, parts of speech abbreviations, and a carriage return and line feed. The first record contains a null for the word and for the part of speech. A failed word search defaults to that first record. With a successful word search, the part(s) of speech are extracted from the record. For about 180 KB words in the dictionary string, a sequential word search returns its string position in less than 25-lines of sequential code and less than 0.01-desktop seconds.

For example, from the phrase “small red wagon”, small and red are deemed as necessary attributes of wagon. To clarify the meaning by expansion, the phrase is read as “wagon is small size and red color” of nouns wagon, size-small, and color-red:

| | |
|---|---|
| wagon: | p |
| size_small: | q |
| necessarily p: | #q |
| color_red: | r |
| necessarily r: | #r |
| is: | = |
| and: | & |
| p = #( q & r): | “wagon is necessarily small-size and red-color” |

This unique approach is named unfolding whereby to achieve proof in one of the models initially not proved, the sentence or phrase may be rewritten or as written into multiple sentences.

Each sentence is evaluated to a logical proof value. The the result of a truth table for each sentence is assigned subsequently as a literal based on its order of appearance in the paragraph. For example, if a sentence has nouns A, B and connective=, then that sentence is assigned as a literal C. If the next sentence has nouns A, B and connective &, then that sentence is assigned as literal D. The connective between the sentences is arbitrarily inserted as the implication connective>based solely on the reason that the sentence producing C is followed by the sentence producing D. In other words, C>D means from C follows D or alternatively D follows from C. This arbitrary reduction of the combined connectives into an implication is a novel approach.

The result of the logical cascade or catenation process applies to subsequent sentences to build a logical proof value as the truth table for the paragraph. Subsequent expressions for each paragraph are similarly processed in order to obtain a logical proof value as the truth table for the entire document.

Concluding Remarks

The output results from Meth8 are bivalent and exact and hence avoid the complexities of the probabilistic mu calculus and inexact temporal logic.

Accordingly, in one aspect, a method for checking proof models as based on VL4 includes a framework to check other logic systems such as the ternary logics of Gödel 1932, Halldén 1949, Kleene 1938, Kleene 1950, Lukasiewicz 1920, Priest 1979 and the quaternary logics of Belnap 1977, Béziau 2011, Lewis and Langford 1959, Kleene 1950, Lukasiewicz 1953, and Rescher 1965.

In another aspect, a method for checking proof models as based on VL4 includes the parsing of natural language into POS, mapping the words by POS into logical expressions, and feeding the logical expressions for other logic systems as checked by the models of VL4.

In yet another aspect, a non-transitory computer readable medium includes instructions for performing the two aspects above.

Still other aspects, features, and advantages of the present invention are readily apparent from the following detailed description, simply by illustrating a number of exemplary embodiments and implementations, including the preferred mode contemplated for carrying out the present invention. The present invention is also capable of other and different embodiments, and its several details can be modified in various respects, all without departing from the spirit and scope of the present invention. Accordingly, the drawings and descriptions are to be regarded as illustrative in nature, and not as restrictive.

### DETAILED DESCRIPTION OF THE PREFERRED EMBODIMENTS

The system described below is in two parts based on computer machines in FIG. 1.0 and FIG. 2.0 with derivative drawings in FIGS. 1.2-1.8 and FIGS. 2.2-2.8.

FIG. 1.0 LMC describes the computer machine of Step 100 for input of a logical expression to the logic model checker (LMC) with output based on the five models of VL4, with Steps 110, 120, 130, 140, 150, 160, 170, and 180 described below.

In FIG. 1.0 LMC, Step 110 initializes global constants and defines variable assignments.

In FIG. 1.2 LUT, Step 120 builds look up tables (LUT) for two sets of four-valued logic: Step 122 of FCNT is for False, Contingent, Non contingent, and True (the designated value); and Step 123 of UIPE is for Unevaluated, Improper, Proper, and Evaluated (the designated value). The Step 121 LUT is for the negation operator of Not (˜), modal operators of necessarily (#) and possibly (%), and the Step 124 LUT is for connectives &+−<=>@\ for and, or, nor, not imply, equivalent, imply, not equivalent (xor), nand.

In FIG. 1.0 LMC, Step 130 is the input segment to accept a logical expression. In the logic system VL4 with four-valued logic, for a proposition there are 16 logical values in a truth table, or four per row, for each of the five logic models. For a theorem there are 256 logical values in a truth table, or 64 per row, for each of the five logic models. In other words, the number of values in a truth table for propositions is the square-root of that for theorems.

In FIG. 1.4 ILV (input logic validation), Step 140 is a validation segment. It enforces the Character Set and Syntax for input expressions, discards space characters, reduces adjacent duplicate characters, rejects characters not allowed in the character set, flags a missing literal or connective, checks for ambiguous expressions, and counts modifiers, parentheses, literals, and connectives to process by arithmetic for correctness. The unique algorithm used is linear: literal+connective−parentheses+2=k; k is valid if 0 or 1. On mistakes, Step 140 redirects program flow backward to Step 130 for more input or otherwise directs program flow forward to Step 150.

In FIG. 1.5 LPP (logic parse process), Step 150 is the parsing segment to decompose the logical expression into logical arguments. Step 151 uses the unique shift-window parsing (SWP) to determine character boundaries of arguments. Step 152 builds statistics for the conditional, antecedent literal, and consequent literal. Step 153 assigns positions of characters for logical arguments as driven by the position of the conditional.

In FIG. 1.6 LPV (logic parse validation), Step 160 is validation segment. It reports on exceptions raised from Step 150. If the logical expression is a well formed function (wff), then Step 161 redirects program flow backward to Step 130 for more input or otherwise directs program flow forward to Step 170.

In FIG. 1.7 SOA (substitution of argument), Step 170 is the processing segment. Step 171 substitutes truth values for the logical symbols in logical expressions for modifier (negation and modal operators), literal (antecedent and consequent), and connective with its truth table result elevated. When an argument is processed into logical values, its result is elevated to the next level of evaluation precedence. In this sequence in Step 172, the conditional variable of the next level may be used to hold non-conditional symbols such as modifiers. This unique use of overloading is named conditional symbol spoofing (CSS). Step 173 terminates the process when no more levels of argument are available for substitution.

In FIG. 1.8 MPO (model proof output), Step 180 is the output segment. It reports the five models for each logical argument at each level of evaluation as truth table values. The last level of evaluation is for the final results of the models with proof validation by one or more of the models. Step 181 directs the output to a persistent file, and Step 182 directs the output to the desktop monitor.

FIG. 2.0 POSM (parts of speech mapper) describes the computer machine of Step 200 for mapping parts of speech (POS) of the input sentence into expressions of logic for output, with Steps 210, 220, 230, 240, 250, 260, 270, and 280 described below.

In FIG. 2.0 POSM, Step 210 initializes global constants and defines variable assignments.

In FIG. 2.2 POSD (parts of speech dictionary), Step 220 builds the word dictionary with respective parts of speech. Step 221 reads the dictionary from an external file into a single search string of about 2.5 MB; the first record contains null for the word and null for the parts of speech. The source of the external list is modified from a public domain file named “mpos.tar.Z” for “Moby part-of-speech II”. A word may have multiple parts of speech for the context range of usage. The noun includes the forms of singular, plural, pronoun, and noun phrases. The verb includes the forms of intransitive, transitive, participle, gerund, and conjunction. The adjective includes the forms of preposition and definite and indefinite article. (The inclusion of the conjunction in the abstract verb group and the preposition in the abstract adjective group are examples of abstract clustering.) For the adjective or adverb, three logical states are mapped respectively below in Step 260 or Step 270, as: not or never; necessary or necessarily; and possible or possibly. The dictionary list excludes interjections and nominatives. Step 222 allows nouns, noun modifiers verbs, and verb modifiers. Step 223 disallows non English words, noun phrases, interjections, and nominatives. Step 224 allows for the special dictionary format including the sentinel characters of comma and carriage return/line feed.

In FIG. 2.0 POSM, Step 230 is the input segment to accept a natural language expression of words, such as a sentence, and the designation of it as a proposition or theorem.

In FIG. 2.4 NLSV (natural language sentence validation), Step 240 is a validation segment. Step 241 allows the ASCII characters 1-127 and disallows the ASCII characters (128-255). If a character is disallowed, then Step 240 redirects the program flow back to Step 230 for more input or otherwise directs the program flow forward to Step 250.

In FIG. 2.5 POSS (parts of speech search), Step 250 is the search and retrieval segment for the POS. Step 251 performs a sequential search for the word in the dictionary string. Step 252 retrieves the (multiple) parts of speech for the word as in the list <A, B, N V> for respectively the list <adjective, adverb, noun, verb>.

In a preferred embodiment, the first record of the dictionary from Step 221 contains a null for both the word and POS. An unsuccessful word search defaults to that first record and an exception is raised in Step 250.

In FIG. 2.6 POSV (parts of speech validation), Step 260 is a validation segment. Step 261 counts the number of nouns and verbs of the word expression where two nouns exist for one verb.

The POS is evaluated to fit the word placement and context in the sentence. For example, consider the word “jump”. In the context of the sentence “The next index pointer can jump backward”, the “jump” is a verb. In the context of the sentence “The jump is forward to the next index pointer”, the “jump” is a noun. In a preferred embodiment of the invention, Step 260 correctly chooses the POS as based on how the word “jump” is used in the context of the instant sentence.

In FIG. 2.7 POSL (parts of speech validation), Step 270 is the mapping segment. The POS is mapped to the logical symbol of the literal in Step 271, the conditional in Step 272, and the modifier in Step 273. In the case of POS as a noun in Step 271, the logical symbol is mapped respectively to the literal of a theorem or the literal of a proposition: that designation is made in Step 230. In the case of the POS as an adjective or an adverb in Step 273, the logical symbol is respectively mapped: to a negation operator as not or never; and to the modal modifiers as necessary or necessarily, or as possible or possibly.

In FIG. 2.8 (LESO) Step 280 is the output segment. It reports the logical expression to a persistent file by Step 281 and the desktop monitor by Step 282.

According to an embodiment of the invention, the output result from Step 280 may serve as the input to FIG. 1.0 LCM at Step 130.

A preferred embodiment is described to include a novel approach to connecting logical expressions into paragraphs a requirement document. This is the abstraction of assigning sentences (and then paragraphs) to literals that are linked by other sentences (and then paragraphs) serving as connectives. Absent a plausible abstract connective, a novel approach is to use implication connective between successive abstract literals.

For example, each sentence after mapping to a logical expression is assigned subsequently as an abstract literal, connective, or modifier based on the list of its variables. If a sentence has nouns A, B and connective =, then that sentence is assigned as a literal C. If the next sentence has nouns A, B and connective &, then that sentence is assigned as literal D. The connective between the sentences is arbitrarily inserted as the implication connective>based solely on the reason that the sentence producing C is followed by the sentence producing D. In other words, C>D means from C follows D or alternatively D follows from C. This arbitrary reduction of the combined connectives into an implication is this novel approach.

The result of the logical cascade or catenation process applies to subsequent sentences to build an expression for the paragraph. Subsequent expressions for each paragraph are similarly catenated for the entire requirement document.

Although the exemplary embodiments are described herein, the present invention is applicable to machine cognition, as will be appreciated by those skilled in the art(s).

Further, systems described can include at least one computer readable medium or memory for holding instructions programmed according to the teachings of the invention and for containing data structures, tables, records, or other data described herein. Common forms of computer-readable media can include, for example, a floppy disk, a flexible disk, hard disk, memory disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media can be involved in providing instructions to a processor for execution. For example, the instructions for carrying out at least part of the embodiments of the present invention can initially be borne on a magnetic disk of a remote computer connected to one or more network. In such a scenario, the remote computer can load the instructions into main memory and send the instructions, for example, over a telephone line using a modem. A modem of a local computer system can receive the data on the telephone line and use an infrared transmitter to convert the data to an infrared signal and transmit the infrared signal to a portable computing device, such as a PDA, a laptop, an Internet appliance, etc. An infrared detector on the portable computing device can receive the information and instructions borne by the infrared signal and place the data on a bus. The bus can convey the data to main memory, from which a processor retrieves and executes the instructions. The instructions received by main memory can optionally be stored on storage device either before or after execution by processor.

While the present invention was described in connection with a number of exemplary embodiments and implementations, the present invention is not so limited but rather covers various modifications and equivalent arrangements, which fall within the purview of the appended claims.

What is claimed is:

1. An apparatus for checking natural language in proof models of modal logic, comprising computational equipment.
